(19) United States
(12) Patent Application Publication
(10) Pub. No.: US 2007/0038324 A1
(43) Pub. Date: Feb. 15, 2007

(54) Recipe operation using group function and/or subroutine function

(75) Inventors: Masahiro Takizawa, Tokyo (JP); Tsutomu Makino, Tokyo (JP); Kazuyoshi Ishigaya, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 11/201,510

(22) Filed: Aug. 11, 2005

(51) Int. Cl. G06F 19/00

(52) U.S. Cl. 700/105

(57) ABSTRACT

A recipe operation system includes (i) at least one recipe comprised of multiple operation steps arranged in order; and (ii) a recipe execution program including a subroutine which is called every time steps are changed, to select a next step to be executed from the steps arranged in order. The steps are executed in order different from the arranged order, and at least one step is repeated.

### BACKGROUND OF THE INVENTION

1. Field of the Invention

The present invention relates to a recipe control processing technique executed on a semiconductor-manufacturing apparatus and a control software program running on a semiconductor-manufacturing apparatus, etc.

2. Description of the Related Art

In a semiconductor-manufacturing process, manufacturing processing such as film deposition and wafer cleaning are executed using an apparatus control format called a recipe. As instructed in a recipe format, by inputting set values for a flow, a temperature, a pressure of a process gas for each oeration step and values for time assigned to each operation step, an operator controls a semiconductor-manufacturing apparatus to obtain desired process results. In other words, it can be said that creating a recipe is an essential part for the operator to control the semiconductor-manufacturing apparatus.

Generally, it is a common practice that a recipe is created on an operation screen (Man Machine Interface: MMI) of a controller in a semiconductor-manufacturing apparatus and stored in a computer file format on a memory device (Hard Disk: HD) such as a magnetic disk, read into the main memory such as random access memory (RAM) from the HD, and executed. Additionally, in automation processing using an online system in recent years, recipes are collectively stored on a host computer connected with a manufacturing apparatus and a necessary recipe is downloaded to the apparatus only when wafer lot processing is executed. This is a desirable way of the processing from a viewpoint of centralized control of the manufacturing process.

In recent years, semiconductor film types to be manufactured increases; with the increase, recipe types to be used also go on increasing. Further, even for a recipe for the same film type, a recipe with changed conditions such as a gas flow, a pressure and a temperature may be required in accordance with aging of a processing container or its service condition. Additionally, in a film deposition process for a certain film type, some film deposition processing includes repetition of a brief step operation multiple times in order to achieve an atomic layer level of film thickness. In this case, the number of recipe operation steps increases as the number of repeated steps increases.

A problem directly caused by these phenomena is shortage of memory capacity of a controller. When the number of recipes is large, it is possible to manage the recipes using a distributed system; the number of files, however, increases and management cost rises. Additionally, when a file size of each recipe becomes larger by repeating steps, shortage of memory capacity becomes a problem. Further, when a condition or a parameter is changed in a recipe having many step operation repeats, time and labor required for corrections increase because more places need to be changed.

As an example of standardizing recipe operation steps, Japanese Patent Laid-open No. 1997-82589 is disclosed. Here, however, a sub-recipe which is created from an operation step common to multiple recipes is stored in a different file from a file the recipes are stored and called up when needed; the order of executing operation steps within a single recipe and repeated processing of multiple operation steps are not mentioned; therefore, there is a problem to apply this method to the above-mentioned particular film deposition processing.

### SUMMARY OF THE INVENTION

Accordingly, an object of one embodiment of the present invention is to implement standardization of a repeated portion in a recipe used in the processing in which multiple operation steps are executed repeatedly. By this, repeating descriptions in a recipe can be avoided, hence a file size of the recipe does not increase and a memory capacity of an apparatus controller can be kept from increasing. Additionally, depending on a processing apparatus, there is a case in which respective upper limits on a recipe operation step size and a file size are fixed. In this case as well, through the effect of reduction in the number of operation steps, it becomes possible to implement a recipe exceeding an upper limit on an operation step size. Additionally, when a recipe is transferred between apparatus controllers and only step data is transferred, it becomes possible to increase a recipe transfer rate, or in an embodiment of the present invention, it aims at reducing memory capacity of a memory device in a semiconductor-manufacturing apparatus system, etc. as well as shortening description in a semiconductor-manufacturing recipe having a large number of operation steps using a group function or a subroutine function.

The present invention can accomplish one or more of the above-mentioned objects in various embodiments. However, the present invention is not limited to the above objects, and in embodiments, the present invention exhibits effects other than the objects.

In an aspect, the present invention provides a recipe operation system comprising: (i) at least one recipe comprised of multiple operation steps arranged in order; and (ii) a recipe execution program comprising a subroutine which is called every time steps are changed, to select a next step to be executed from the steps arranged in order, wherein the steps are executed in order different from the arranged order, and at least one step is repeated.

The above embodiment includes, but is not limited to, the following embodiments:

At least one group of steps in the operation steps arranged in order may be sequentially executed more than once until all of the operation steps in the recipe are executed.

A first step of the group may have a start flag, and a last step of the group has an end flag.

The subroutine may be configured to select the next step using information on the start flag, the end flag, and the number of times the group is repeated.

The group may be arranged upstream of a last step of the recipe. The group may be arranged downstream of a last step of the recipe.

When the group is arranged downstream of a last step of the recipe, the operation steps may include at least one step having a group call flag upstream of the last step of the recipe. The at least one step having a group call flag may regulate analogue data (such as gas flow), and the group of steps regulates on-off data (such as opening/closing valves) without changing the analogue data. In the above, the step having the group call flag can regulate the analogue data in the group of steps while the group of steps is being executed, and the group of steps can regulate on-off data only. The subroutine may be configured to select the next step using information on the group call flag, the start flag, the end flag, and the number of times the group is repeated. The at least one step may be comprised of more than one steps.

The recipe may be stored in a single file.

In another aspect, the present invention provides an apparatus for processing an object, comprising: (i) a chamber for processing the object therein; (ii) a controller for controlling processes carried out in the chamber; and (iii) the recipe operation system of claim 1 provided in the controller, wherein the multiple operation steps are steps of processing the object in the chamber.

The above embodiment includes, but is not limited to, the following embodiments:

The apparatus may be a semiconductor-manufacturing apparatus, wherein the chamber is a reaction chamber, the object is a semiconductor substrate, and the operation steps are for film deposition. The recipe may be stored in a single file in the controller.

At least one group of steps in the operation steps arranged in order may be sequentially executed more than once until all of the operation steps in the recipe are executed. The group of steps may regulate gas flow operation. The group of steps may be arranged upstream of a last step of the recipe. The group of steps may be arranged downstream of a last step of the recipe. The group of steps may regulate on-off of gas control valves.

In still another aspect, the present invention provides a method of recipe operation comprising: (i) formulate at least one recipe comprised of multiple operation steps arranged in order; and (ii) formulate a recipe execution program comprising a subroutine which is called every time steps are changed, to select a next step to be executed from the steps arranged in order, wherein the steps are executed in order different from the arranged order, and at least one step is repeated.

In all of the aforesaid aspects and embodiments, any element used in an aspect or embodiment can interchangeably or additionally be used in another embodiment in various combinations unless such a replacement is not feasible or causes adverse effect.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 shows an implementation example of a recipe editor displayed on a control screen of a controller in a semiconductor-manufacturing apparatus according to an embodiment of the present invention.

FIG. 2 shows an example of step numbers and step flags of a semiconductor-manufacturing recipe in an embodiment of the present invention.

FIG. 3 shows an example of step numbers and step flags when a group function of a semiconductor-manufacturing recipe is used in an embodiment of the present invention.

FIG. 4 shows an example of step numbers and step flags when a subroutine function of a semiconductor-manufacturing recipe is used in an embodiment of the present invention.

FIG. 5 is a flowchart for explaining the group function of a semiconductor-manufacturing recipe in an embodiment of the present invention.

FIG. 6 is a flowchart for explaining the subroutine function of a semiconductor-manufacturing recipe in an embodiment of the present invention.

FIG. 7 shows an implementation example of various settings of group and subroutine functions for each recipe step in an embodiment of the present invention.

FIG. 8 is a flowchart showing step execution in an embodiment of the present invention.

FIG. 9 is a schematic view showing an example of a system configuration of a semiconductor-manufacturing apparatus which can be used in the present invention.

### DETAILED DESCRIPTION OF THE PREFERRED EMBODIMENT

According to an embodiment achieving one or more objects mentioned above, the present invention collectively registers several recipe steps repeated in a recipe as one group within the recipe. A group exists between a start flag and an end flag of the recipe and it is “a group function” that prescribes the number of times the group is repeated. Additionally, it is “a subroutine function” that a group is placed outside a sequence of the start flag to the end flag of a recipe and accessed from any step in the recipe, and that recipe operation is started from the following step in an original recipe upon completion of all steps (a subroutine called up when a step of deciding a next step number is executed means a function and is distinguished from the above-mentioned “subroutine function”). By using these two different functions, it becomes possible to reduce the number of operation steps in the recipe substantially, and the time and labor required for recipe correction can also be cut down. Further, it is also possible to reduce a recipe size.

Additionally, “a recipe” specifies conditions for executing a series of processing steps onto a workpiece inside a processing apparatus by control parameters (time, temperature, flow, pressure, etc.) and is composed of multiple steps arranged in order. Normally, one recipe is stored in one file. Additionally, definitions of the above-mentioned terms apply to an embodiment, and a different definition can apply to a different embodiment. In an embodiment, terms are used in the sense which those skilled in the art understand normally or by practice.

The present invention will be explained in detail with reference to preferred embodiments and drawings. However, the preferred embodiments and drawings are not intended to limit the present invention.

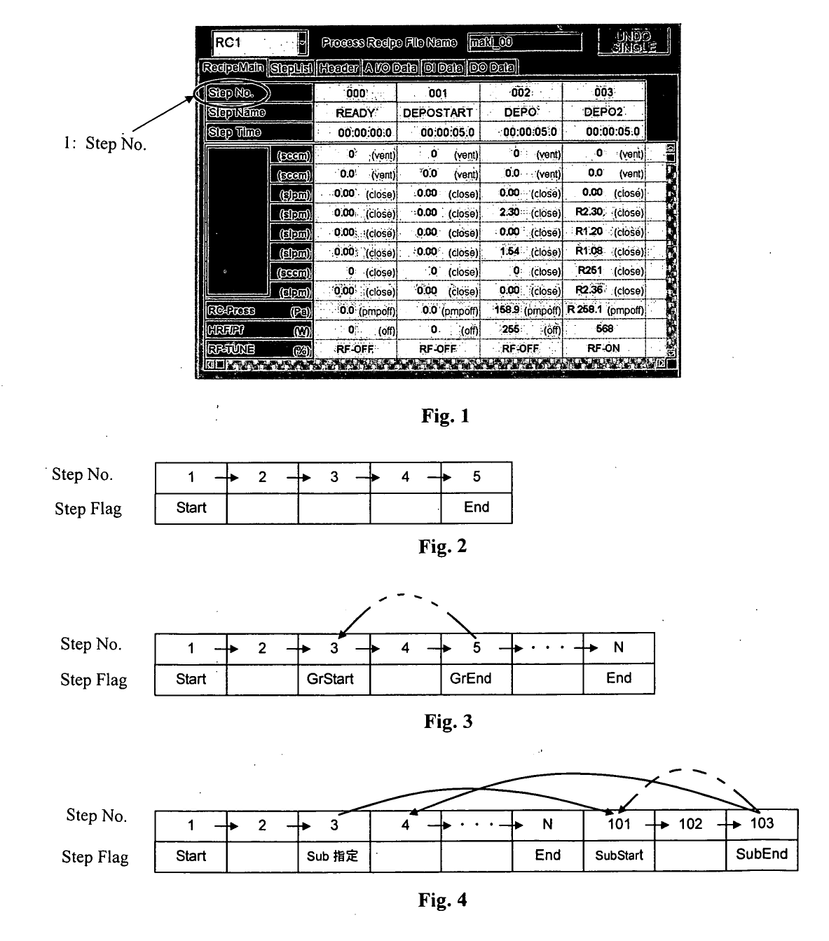

FIG. 1 shows a typical recipe editor screen in a controller MMI of a semiconductor-manufacturing apparatus. Each step is executed in sequence in the order starting from Step Number 1 shown in FIG. 1. A gas type, pressure, temperature, etc. are shown vertically in columns; respective physical values are set for each step (columns for a gas type is omitted). Additionally, time required for each step can be specified. Each step has information called a flag for identifying a step type.

By clicking each step number (000, 001, 002, 003) or each step name (READY, DEPOSTART, DEPO, DEPO2), a screen shown in FIG. 7 and described later is displayed. On the screen shown in FIG. 7, the group function and the subroutine function can be set.

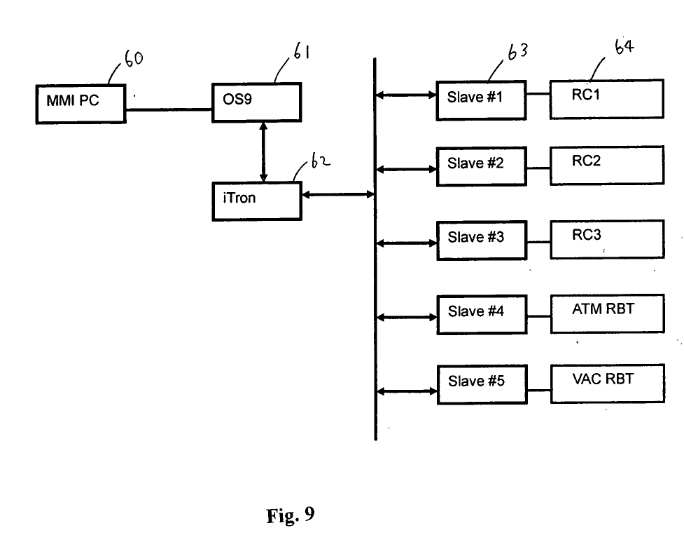

In an embodiment, the group function and the subroutine function are stored in a controller. A block diagram is shown in FIG. 9. MMI PC (60) is a Man Machine Interface PC used for display; OS9 (61) is a CPU board used for communications with MMI PC; iTron (62) is a CPU board functioning as a main controller; Slave (63) is a CPU board used for element control. Additionally, Slave #1 (63) controls RC1 (64), i.e., Reactor 1. In this example, a program executing the group function and the subroutine function is added in order to add operation to the MMI (60), and also in order to add functions to iTron (62) and each Slave (63) for reactor control. Recipes are stored in a HD of the MMI PC (60). When a recipe is executed, the recipe is transferred as follows: MMI→OS9→iTron→RC Slave.

FIG. 2, FIG. 3 and FIG. 4 are schematic drawings showing step numbers and step flags set in a recipe. Using these drawings, the group function and the subroutine function of a recipe will be explained. As shown in FIG. 2, a Start flag (Start) is specified at a first step and an End flag (End) is specified at a last step (Step 5 in this case) in a regular recipe. These flags are to declare the start and the end of a recipe respectively and are always required at the start and at the end of a recipe.

In a regular recipe, steps are started from 1 and executed in order. In FIG. 3, a recipe using the group function is shown. The group function uses a Group Start flag (GrStart) and a Group End flag (GrEnd) which are Step 3 and Step 5 respectively in the recipe shown in FIG. 3. The recipe using the group function is executed starting from Step 1, and steps are executed in order in the same way as a regular recipe is executed. In this case, however, when the recipe operation reaches Step 5 at which the Group End flag is specified, it returns to Step 3 at which the Group Start flag is specified; and steps are executed again in order from Step 3. It is possible to prescribe the number of times returning from Step 5 to Step 3 is repeated, and how to prescribe the number of times of the group is repeated is described later. When the number of times of the group is repeated on is executed, the recipe operation advances ahead from Step 5 and ends at Step N at which an End flag is specified.

In FIG. 4, a recipe using the subroutine function is shown. The subroutine function uses a Subroutine Specification flag (Sub Specification), a Subroutine Start flag (SubStart) and a Subroutine End flag (SubEnd) which are respectively Step 3, Step 101, and Step 103 in the recipe shown in FIG. 4. Additionally, in FIG. 4, step operation from Step 101 to Step 103 is not included in the step operation from a Start flag to an End flag in the recipe. As described above, subroutine steps are prescribed beyond the limits of a recipe. In the case of the recipe shown in FIG. 4, when the step operation reaches Step 3, a Subroutine Start Step is specified in the recipe, which is Step 101 in FIG. 4. It is possible to prescribe the number of times the subroutine is repeated, and how to prescribe the number of times the subroutine is repeated is described later. After the step operation jumps to Step 101, steps are executed in order until a step at which a Subroutine End flag is specified. In this case, when the step operation reaches Step 103, it returns to Step 101 at which the Subroutine Start flag is specified until the prescribed number of times the subroutine is repeated is executed. When the prescribed number of times is executed, the step operation returns to Step 4 in a main recipe from Step 103; and then steps are executed in order and the recipe is completed at Step N at which an End flag is specified.

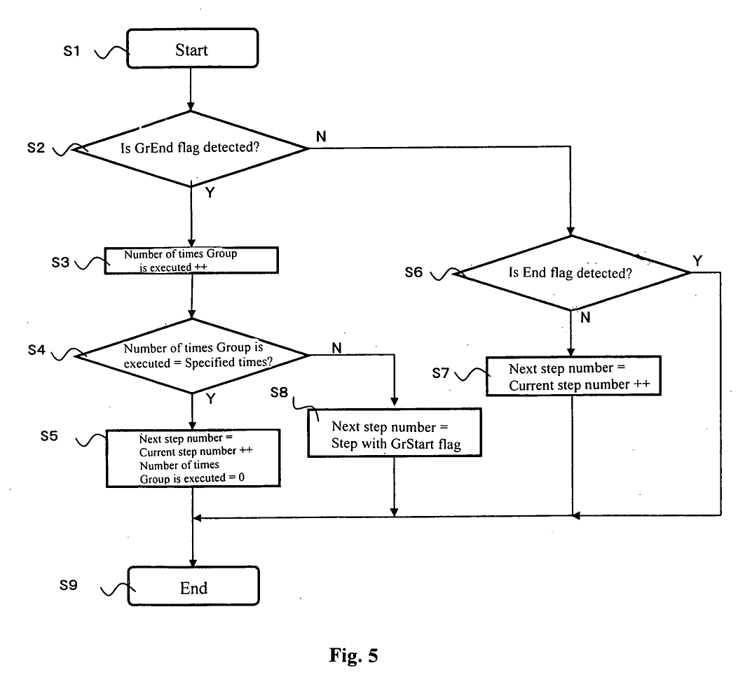

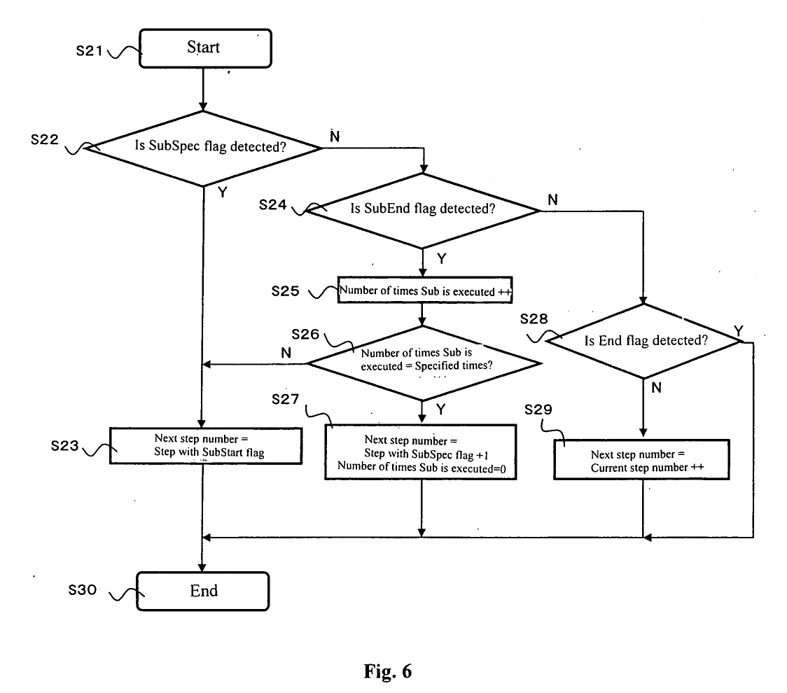

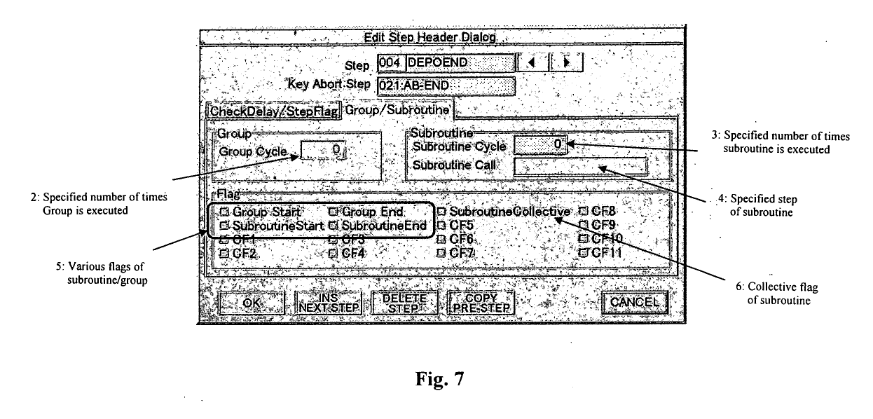

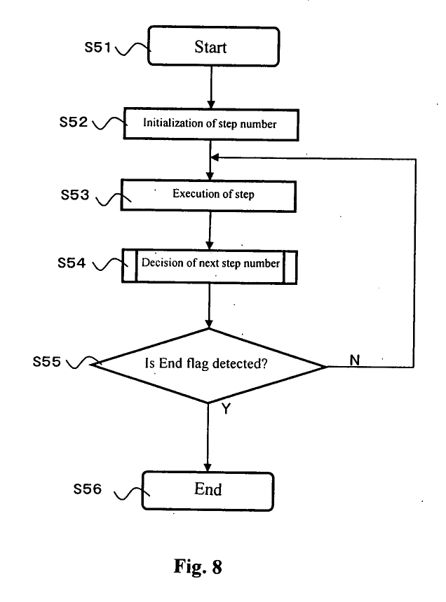

FIG. 5 and FIG. 6 are flowcharts in which actual operations of the group function and the subroutine function are respectively embodied in an embodiment of the present invention. Additionally, these flowcharts are subroutines (functions) called up from a recipe execution program running on a controller in a semiconductor-manufacturing apparatus whenever a recipe step is changed, and show only the subroutines (functions) for deciding a step number to be executed next. Additionally, recipe steps are executed by a separate recipe execution program (FIG. 8) and the recipe steps are not executed here. For the purpose of simplify explanation, the group function and the subroutine function are illustrated separately. In an actual embodiment, however, these two functions may also be combined.

As shown in an embodiment in FIG. 8, when system operation is started (S51), initialization of step numbers in a recipe is executed (S52). After that, a first step is executed (S53) according to the order of step numbers (S53). When the operation advances to a next step, a step to be executed next is decided by calling up a step number decision subroutine (function) (S54). By determining whether an End flag is specified in a next step or not (S55), the operation is ended if the flag is specified (S56); or the operation returns to step execution if the flag is not specified. Flowcharts shown in FIG. 5 and FIG. 6 explain Step 54 at which a next step number is decided.

FIG. 5 is a flowchart of step execution of the group function. Step operation is started from Step 1. At Step 2, a next step, whether a Group End flag (GrEnd) is specified or not is determined. The operation, then, advances to Step 3, a next step, if the flag is specified, or advances to Step 7 if the flag is not specified. At Step 3, the number of times the group is repeated is incremented; at Step 4, whether the number of times the group was executed has reached the prescribed number of the times or not is determined. If the prescribed number of group execution times is fulfilled here, the operation advances to Step 5, a next step; if not, it advances to Step 9. At step 5, a value which is obtained by incrementing a current step number is set as a recipe step number to be executed next, and the number of times the group is executed is brought back to zero. The operation, next, advances to Step 9 and the subroutine (function) is ended. When a Group End flag is not specified at Step 2, the operation advances to Step 6; when a Group End flag is specified at Step 2, the operation still advances to Step 6; and at Step 6, whether a regular Recipe End flag (End) is specified or not is determined. If it is specified, the operation advances to Step 9, an End step. If it is not specified, a value obtained by incrementing a current step number is set at Step 7 as a recipe step number to be executed next; and then, the operation advances to Step 9, the End step. In a decision made at Step 4 on whether the number of times the group was executed has reached the prescribed number of the times or not, if the prescribed number of times is not fulfilled, the operation advances to Step 8; at Step 8, a step number at which a Group Start flag is specified is set as a recipe step number to be executed next.

FIG. 6 is a flowchart of step execution of the subroutine function. The step execution is started from Step 21. At Step 22, a next step, whether a Subroutine Specification flag (Sub Specification) is specified in a recipe or not is determined. If the flag is specified, the operation advances to Step 23, a next step; if it is not specified, the operation advances to Step 24. At Step 23, a step number at which a Subroutine Start flag is specified is set as a recipe step number to be executed next. The operation, next, advances to Step 30 and the subroutine (function) is ended.

When it is determined that a Subroutine Specification flag is not specified at Step 22, the operation advances to Step 24. At Step 24, whether a Subroutine End flag is specified or not is determined. If the flag is specified, the operation advances to Step 25; if it is not specified, the operation advances to Step 28. At Step 25, the number of times the subroutine is executed is incremented; at Step 26, whether the number of times the subroutine was executed has reached the prescribed number of the times or not is determined. If the number of execution times has reached the prescribed number of times, the operation advances to Step 27. If it has not reached, the operation advances to Step 23. At Step 27, a step number which is a next step number of the step at which the Subroutine Specification flag is specified is set as a recipe step number to be executed next, and the number of times the subroutine is executed is brought back to zero.

At Step 23, as mentioned above, a step number at which a Subroutine Start flag is specified is set as a recipe step number to be executed next. The operation, then, advances to Step 30, an End step. When it is determined that the Subroutine End flag is not specified at Step 24, the operation advances to Step 28. At Step 28, whether a regular Recipe End flag (End) is specified or not is determined. If it is specified, the operation advances to Step 30, an End step. If it is not specified, a value obtained by incrementing a current step number is specified at Step 29 as a recipe step number to be executed next.

FIG. 7 shows an example of a setting screen for each recipe shown in FIG. 1. In the Group Cycle entry field 2, how many times a collective of recipe steps prescribed as a group is repeated is specified. In the Subroutine Cycle entry field 3, how many times of a collective of recipe steps prescribed as a subroutine is repeated is specified. In the Subroutine Call entry field 4, a Start step of a subroutine is specified. If the name of a recipe step is entered in this field, the step specified will have a Subroutine Specification flag. Subroutine/Group various flags boxes 5 are the above-mentioned respective Start and End flags of a subroutine and a group. If these boxes are checked, a step specified will have an applicable flag.

The Subroutine Collectives boxes 6 have a special function. If this Collective flag is checked at a recipe step having a Subroutine Specification flag, a display in the control software program can be indicated as if the subroutine is not executed. In other words, while the subroutine is being executed, a step number of a main recipe which specifies the subroutine is displayed as a recipe step number, and the total accumulated subroutine execution time (repeats included) is displayed as step time. Additionally, analogue output settings (gas flow, etc.) for a step whose Subroutine Collective boxes 6 is checked are valid for all steps of a specified subroutine. In other words, in this case, analogue output settings in the subroutine become null. Using this function, time and labor for changing analogue output settings for each step in the subroutine are omitted.

For example, if a Subroutine Collective flag 6 shown in FIG. 7 is checked, an analogue amount (gas flow, etc.) specified at a Subroutine Specification step is fixed and only on-off of gas control valves can be specified by the subroutine and repeated.

The group function and the subroutine function are selected appropriately according to an intended operation. In the case of the group function, a recipe size can be minimized only when a portion needed to be repeated is only in a single place in a recipe. If the subroutine function is applied when a portion needed to be repeated is only in a single place, a recipe size increases by one step (Sub Specification step). In the case of the subroutine function, a recipe size can be minimized when a repeat is needed at multiple places in a recipe. In the case of the group function, if a recipe has the same repeats multiple times, it is necessary to describe steps whenever the same group repeat is included in the recipe. Additionally, in the case of the subroutine function, when the content of a recipe is checked, checking of a flow of the recipe may be difficult because a common portion resides in a separate place from a main body.

For example, in a semiconductor-manufacturing apparatus, when a film deposition process at an atomic layer level of film thickness comprising “gas flow→purge→gas flow→purge . . .” is repeated in short time, it can be efficiently implemented using the group function. Additionally, when plasma is used, RF generation is turned ON after the prescribed number of times a group of steps is repeated is executed; when the same repeat is executed again, the process can be efficiently implemented using the subroutine function. In this case, by using the subroutine function, a recipe size is held down more than a recipe size by using the group function.

In an embodiment, a recipe is as described below if it is expressed by steps arranged in order (An example described below is oversimplified for illustration purposes and it is not in line with the recipe editor shown in FIG. 1.).

<An example of ALD>
Step 1: Start
Step 2: Set temperature and pressure
Step 3: Group Start
Step 4: Film deposition
Step 5: Purge
Step 6: Group End
Step 7: Cleaning processing
Step 8: End

In the above, Step 4 and Step 5 are put between Step 3 and Step 6, and steps from Step 3 to Step 6 form a group of steps. This group of steps is arranged before (upstream of) Step 8 and is repeated until the prescribed number of times the group is repeated as illustrated in the flowchart in FIG. 5 is reached. As described, although a recipe is comprised of steps arranged in order; it is not executed as put in order as a whole because a group of steps is repeated.

<Example of Interlayer Film>
Step 1: Start
Step 2: Set temperature and pressure
Step 3: Specify subroutine
Step 4: RF generator ON
Step 5: Specify subroutine
Step 6: Cleaning processing
Step 8: End
Step 9: Subroutine start
Step 10: Film deposition
Step 11: Purge
Step 12: Subroutine end

In the above, Step 10 and Step 11 are put between Step 9 and Step 12, and a sequence from Step 9 and Step 12 forms a group of steps. This group of steps is arranged beyond (downstream of) Step 8 and is called up respectively at Step 3 and at Step 5 as illustrated in the flowchart in FIG. 6. Although Step 10 and Step 11 within this group of steps are repeated as illustrated in the flowchart in FIG. 6 until the prescribed number of times the group is repeated is executed, these steps may not be repeated. As described, although a recipe is comprised of steps arranged in order; it is not executed as put in order as a whole because a group of steps is repeated.

The group function and the subroutine function can also be combined. For example, within a group of steps prescribed by the subroutine function, a group of steps prescribed by the group function may be arranged. Additionally, the other way around, a group of steps prescribed by the subroutine function may be arranged within a group of steps prescribed by the group function, and a group of steps prescribed by the subroutine function may be arranged downstream of an end step of a recipe. By using the respective two functions separately, the functions may be arranged before and after a step number.

As described above, in an embodiment of the present invention, by describing a group of steps repeated in a recipe using the group function and the subroutine function, it becomes possible to substantially save usage of a memory area on a HD of a controller in a semiconductor-manufacturing apparatus. Additionally, time and labor required for correcting a recipe can be reduced. Further, not limited to a semiconductor-manufacturing apparatus, the present invention can apply to a processing apparatus which includes control of a repeat of the same type of processing. As an apparatus to which recipe control is implemented, a liquid crystal manufacturing apparatus, a magnetic disk manufacturing apparatus, etc. can be mentioned; the present invention is also applicable to these apparatuses. It is apparent to those skilled in the art that the control system according to the present invention can extensively apply to recipe control.

Additionally, the present invention is not limited to embodiments described above; the following embodiments are included as well:

1) A semiconductor-manufacturing apparatus executing recipe control processing, which is characterized in that in the recipe, the order of executing operation steps is different from information of execution order added to an operation step.

2) A semiconductor-manufacturing apparatus executing recipe control processing, which is characterized in that the recipe defines a group of multiple operation steps which is repeated in the recipe by repeat start information, repeat end information and the number of times the group is repeated.

3) The semiconductor-manufacturing apparatus according to 2), which is characterized in that the repeat start information and the repeat end information comprise variable information (flags) included in a control software program running on the semiconductor-manufacturing apparatus.

4) The semiconductor-manufacturing apparatus according to 2), which is characterized in that the recipe executes an operation step having the repeat start information subsequently to an operation step having the repeat end information until the number of times the group is repeated is executed.

5) A semiconductor-manufacturing apparatus executing recipe control processing, which is characterized in that the recipe prescribes a group of multiple operation steps to be executed repeatedly inside it outside a sequence of an operation step having recipe start information to an operation step having recipe end information and defines the group by group point information, group start information, group end information and the number of times the groups is repeated.

6) The semiconductor-manufacturing apparatus according to 5), which is characterized in that the group start information and the group end information comprise variable information (flags) included in a control software program running on the semiconductor-manufacturing apparatus

7) The semiconductor-manufacturing apparatus according to 5), which is characterized in that setting of a controlled physical amount at an operation step having the group point information becomes valid for all operation steps within the group.

8) The semiconductor-manufacturing apparatus according to 5), which is characterized in that the recipe executes an operation step having the group start information subsequently to an operation step having the group point information.

9) The semiconductor-manufacturing apparatus according to 5), which is characterized in that the recipe executes an operation step having the group start information subsequently to an operation step having the group end information until the number of times the group is repeated is executed.

10) The semiconductor-manufacturing apparatus according to 5) above, which is characterized in that after execution of the number of times the group is repeated is ended, the recipe executes a next operation step to an operation step having the group point information subsequently to an operation step having the group end information.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A recipe operation system comprising:
at least one recipe comprised of multiple operation steps arranged in order; and
a recipe execution program comprising a subroutine which is called every time steps are changed, to select a next step to be executed from the steps arranged in order, wherein the steps are executed in order different from the arranged order, and at least one step is repeated.

2. The recipe operation system according to claim 1, wherein at least one group of steps in the operation steps arranged in order is sequentially executed more than once until all of the operation steps in the recipe are executed.

3. The recipe operation system according to claim 2, wherein a first step of the group has a start flag, and a last step of the group has an end flag.

4. The recipe operation system according to claim 3, wherein the subroutine is configure to select the next step using information on the start flag, the end flag, and the number of times the group is repeated.

5. The recipe operation system according to claim 3, wherein the group is arranged upstream of a last step of the recipe.

6. The recipe operation system according to claim 3, wherein the group is arranged downstream of a last step of the recipe.

7. The recipe operation system according to claim 6, wherein the operation steps include at least one step having a group call flag upstream of the last step of the recipe.

8. The recipe operation system according to claim 7, wherein the at least one step having a group call flag regulates analogue data in the group of steps, and the group of steps regulates on-off data without changing the analogue data.

9. The recipe operation system according to claim 7, wherein the subroutine is configure to select the next step using information on the group call flag, the start flag, the end flag, and the number of times the group is repeated.

10. The recipe operation system according to claim 7, wherein the at least one step is comprised of more than one steps.

11. The recipe operation system according to claim 1, wherein the recipe is stored in a single file.

12. An apparatus for processing an object, comprising:
a chamber for processing the object therein;
a controller for controlling processes carried out in the chamber; and
the recipe operation system of claim 1 provided in the controller, wherein the multiple operation steps are steps of processing the object in the chamber.

13. The apparatus according to claim 12, wherein the recipe is stored in a single file in the controller.

14. The apparatus according to claim 12, which is a semiconductor-manufacturing apparatus, wherein the chamber is a reaction chamber, the object is a semiconductor substrate, and the operation steps are for film deposition.

15. The apparatus according to claim 14, wherein the recipe is stored in a single file in the controller.

16. The apparatus according to claim 12, wherein at least one group of steps in the operation steps arranged in order is sequentially executed more than once until all of the operation steps in the recipe are executed.

17. The apparatus according to claim 16, wherein the group of steps regulate gas flow operation.

18. The apparatus according to claim 16, wherein the group of steps is arranged upstream of a last step of the recipe.

19. The apparatus according to claim 16, wherein the group of steps is arranged downstream of a last step of the recipe.

20. The apparatus according to claim 19, wherein the group of steps regulates on-off of gas control valves.

21. A method of recipe operation comprising:
formulate at least one recipe comprised of multiple operation steps arranged in order; and
formulate a recipe execution program comprising a subroutine which is called every time steps are changed, to select a next step to be executed from the steps arranged in order, wherein the steps are executed in order different from the arranged order, and at least one step is repeated.

22. The method according to claim 21, further comprising identifying a group of steps which is repeated in the operation steps, and placing a start flag in a first step of the group and an end flag in a last step of the group.

23. The method according to claim 22, wherein the subroutine selects the next step using information on the start flag, the end flag, and the number of times the group is repeated.

24. The method according to claim 22, wherein the group is arranged upstream of a last step of the recipe.

25. The method according to claim 22, wherein the group is arranged downstream of a last step of the recipe, and the method further comprises placing a group call flag in at least one step upstream of the last step of the recipe where the group is to be sequentially executed.

26. The method according to claim 25, wherein the subroutine selects the next step using information on the group call flag, the start flag, the end flag, and the number of times the group is repeated.

27. The method according to claim 21, wherein the recipe is stored in a single file.

28. The method according to claim 21, wherein the recipe is for processing a semiconductor substrate.

29. The apparatus according to claim 22, wherein the recipe is for processing a semiconductor substrate, and the group of steps regulates gas flow operation.
